(19) United States
(12) Patent Application Publication
(10) Pub. No.: US 2016/0154545 A1
(43) Pub. Date: Jun. 2, 2016

(54) ELECTRONIC DEVICE AND METHOD FOR MANAGING AND DISPLAYING APPLICATION ICONS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-SAN CHIANG, New Taipei (TW); NIAN-LONG HUANG, Shenzhen (CN); HUA-DONG CHENG, Shenzhen (CN)

(21) Appl. No.: 14/716,525

(22) Filed: May 19, 2015

(30) Foreign Application Priority Data
Nov. 28, 2014 (CN) 201410709978.5

(51) Int. Cl. G06F 3/0482; G06F 3/0484; G06F 3/0481

(52) U.S. Cl. CPC G06F 3/0482; G06F 3/04817; G06F 3/04842

(57) ABSTRACT

In a method for managing and displaying application icons, all icons or selected icons of application software installed in an electronic device are selected by a user. A title, a short menu, and/or a view window of the application software corresponding to each of the selected application icons are generated. The selected application icons can be displayed in a certain shape and in a cascading style according to usage frequencies of each application.

### CROSS-REFERENCE TO RELATED APPLICATIONS

This application claims priority to Chinese Patent Application No. 201410709978.5 filed on Nov. 28, 2014, the contents of which are incorporated by reference herein.

### FIELD

The subject matter herein generally relates to managing application software, and particularly to electronic device and method for managing and displaying application icons on an electronic device.

### BACKGROUND

An electronic device, such as a smart phone, can be installed with a plurality of application software. Usually, icons of the application software (application icons) are displayed on an interface of the electronic device in a style as illustrated in FIG. 1. However, when a number of the application software becomes large, there may be not enough space to display the application icons of all the application software.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an example of an application icons displaying style in prior art.

FIG. 2 is a block diagram of one embodiment of an electronic device for managing and displaying application icons.

FIG. 3 is a block diagram of one embodiment of function modules of an application icons displaying system in FIG. 1.

FIG. 4 is a flowchart of one embodiment of a method for managing and displaying application icons.

FIG. 5 is an example of shapes, titles, and shortcut menus applied to application icons.

FIG. 6 shows two examples of a cascading style of presenting application icons in a display.

### DETAILED DESCRIPTION

It will be appreciated that for simplicity and clarity of illustration, where appropriate, reference numerals have been repeated among the different figures to indicate corresponding or analogous elements. In addition, numerous specific details are given in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

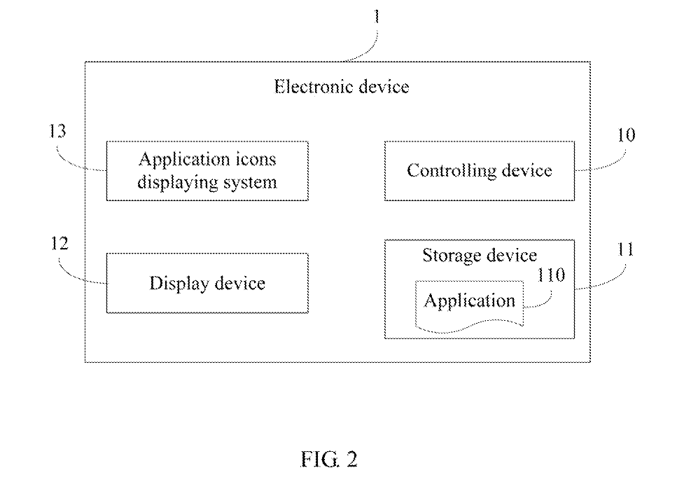

FIG. 2 is a block diagram of one embodiment of an electronic device. The electronic device 1 may be, but is not limited to, a smart phone, a personal digital assistant (PDA), a tablet computer, or any other suitable electronic device. The electronic device 1 can includes an application icons displaying system 13, a controlling device 10, a storage device 11, and a display device 12. FIG. 2 illustrates only one example of the electronic device 1, other examples can include more or fewer components than illustrated, or have a different configuration of the various components in other embodiments.

The application icons displaying system 13 includes computerized codes that, when executed by the controlling device 10, manage and display application icons of application software (hereinafter “applications”) 110 installed in the electronic device 1. The applications 110 are one or more programs designed to permit the user to perform a group of coordinated functions, tasks, or activities. The applications 110 may include programs such as accounting software, media players, and suites of office software. The computerized codes of the application icons displaying system 13 and the application 110 can be stored in the storage device 11.

The controlling device 10 can be a central processing unit (CPU), a microprocessor, or other data processor chip.

The storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium.

The display device 12 is an output device for presentation of information in visual form.

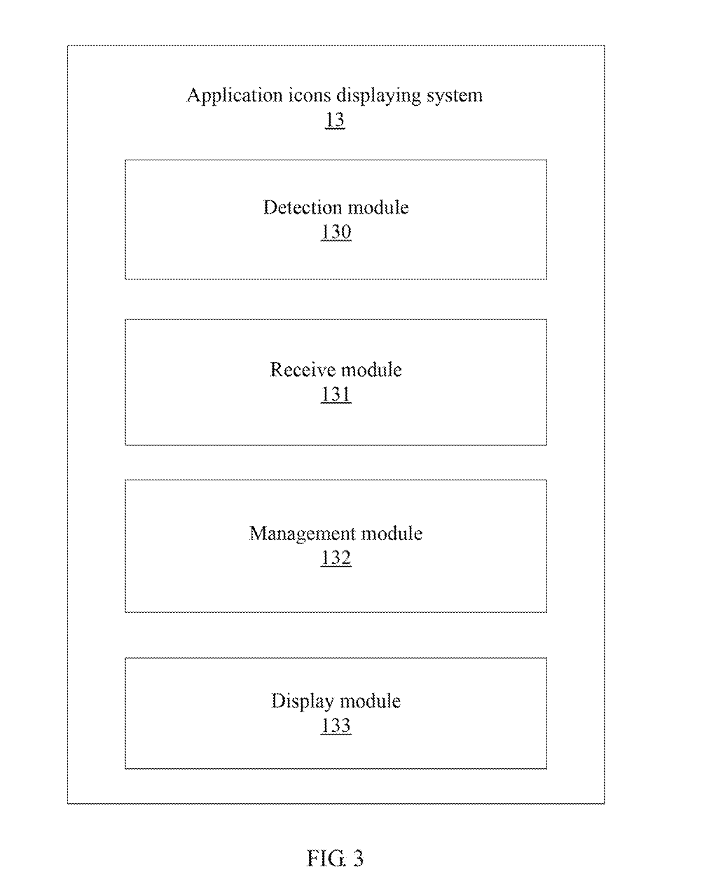

FIG. 3 is a block diagram of one embodiment of function modules of the application icons displaying system. In one embodiment, the function modules of the application icons displaying system 13 can include a detection module 130, a receive module 131, a management module 132, and a display module 133.

The detection module 130 can detect one or more application icons of the applications 110 which are selected by a user. In one embodiment, the detection module 130 can provide a list of application icons of all of the applications 110 installed in the electronic device 1, and provide a check box to each of the application icons. When a check box is selected by a user, the detection module 130 can identify the application icon corresponding to the selected check box. In addition, the detection module can also provide a button to select application icons of all of the applications 110 in one operation.

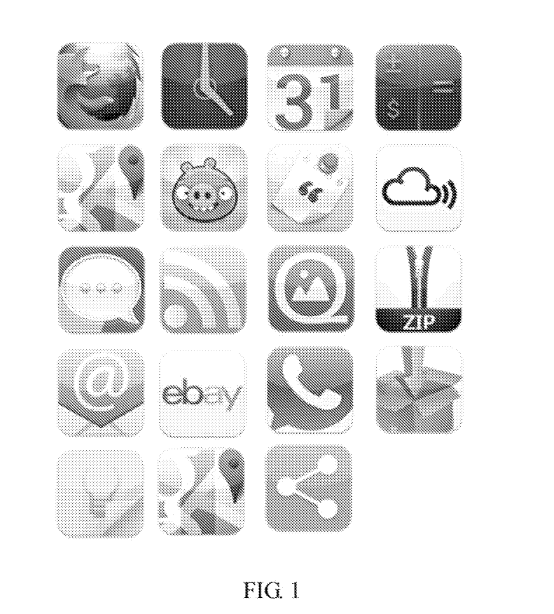

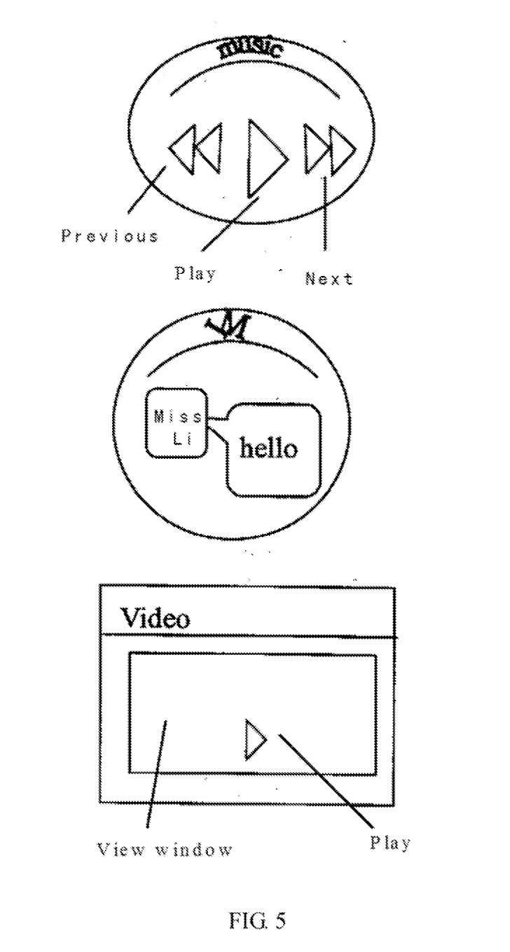

The receive module 131 can receive a shape of the selected application icons. As the examples in FIG. 1 illustrate, a shape of all the application icons is the usual rounded square before. In one embodiment of the present disclosure, the selected application icons can be set to any shape, such as a circle, an oval, a rhombus, or any irregular shape, as shown in FIG. 5, to meet the individual and personalized needs of the user. In one embodiment, the receive module 131 can provide one or more default shapes for selection by the user. Alternatively or additionally, the receive module 131 also can provide an interface on the display device 12, for the user to design the shape(s) of the selected application icons. The receive module 131 receives the shape(s) of the selected application icons that are selected or designed by the user.

The management module 132 can determine a title, a short menu, and/or a view window of the application corresponding to each of the selected application icons. As illustrated in FIG. 5, when an application corresponding to one of the selected application icons is a media player, the management module 132 can render at least one of a title “video,” a shortcut menu including previous button, a play button, and a next button, and a view window that can output a video. In one embodiment, the title, the short menu, and/or the view window of application corresponding to each of the application icons can be preset and stored in the storage device 11.

The management module 132 further can acquire usage frequencies of the applications corresponding to the selected application icons. In one embodiment, the storage device 11 can includes a table to record the usage frequencies of the applications 110. In one embodiment, the usage frequency may be determined over a period of one day or over another predetermined duration, such as over a period of one week or a month.

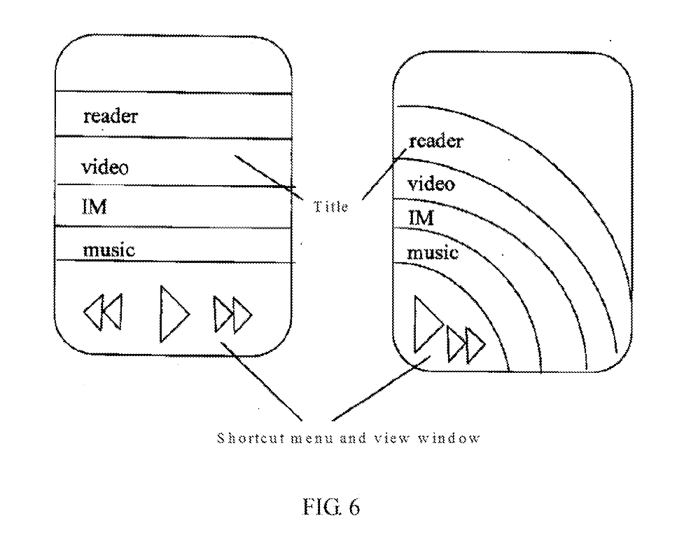

The display module 133 can sequence the selected application icons according to the usage frequencies, and display the selected application icons in a cascading style on the display device 12, according to the sequencing and according to the shapes, such as illustrated in FIG. 6. In one embodiment, an application icon of an application which is used most frequently is at the beginning of the sequence. In one embodiment, when an application icon is selected, the application icons can be switched to be at the front of the sequence. In one embodiment, when displaying the selected application icons in a cascading style, the application icons following the first icon show only their titles.

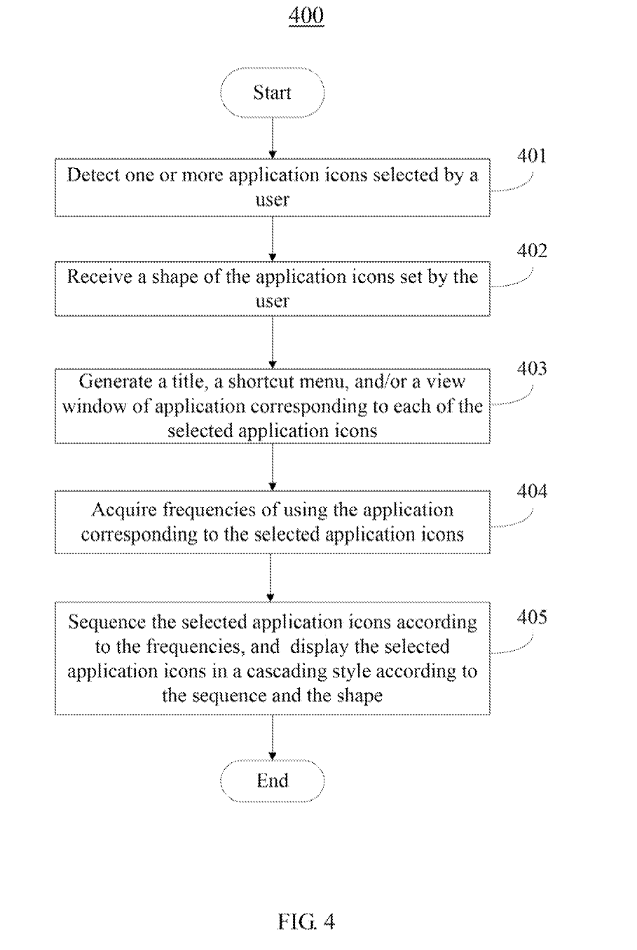

FIG. 4 is a flowchart of one embodiment of a method for managing and displaying application icons.

Referring to FIG. 4, a flowchart is presented in accordance with an example embodiment illustrated. The example method 400 is provided by way of example, as there are a variety of ways to carry out the method. The method 400 described below can be carried out using the configurations illustrated in FIGS. 2 and 3, for example, and various elements of these figures are referenced in explaining example method 400. Each block shown in FIG. 4 represents one or more processes, methods, or subroutines carried out in the exemplary method 400. Furthermore, the illustrated order of blocks is by example only and the order of the blocks can change. Additional blocks may be added or fewer blocks may be utilized, without departing from this disclosure. The exemplary method 400 can begin at block 401.

At block 401, a detection module detects one or more application icons of application software installed in an electronic device and selected by a user. In one embodiment, the detection module can provide a list of application icons of all of the application software, and provide a check box to each of the application icons. When a check box is selected by a user, the detection module can identify the application icon corresponding to the selected check box. In addition, the detection module can also provide a button to select application icons of all of the applications in one operation.

At block 402, a receive module receives a shape of each of the selected application icons. In one embodiment of the present disclosure, each of the selected application icons can be set to any shape, such as a circle, an oval, a rhombus, or any irregular shape, as shown in FIG. 5, to meet the individual and personalized needs of the user. In one embodiment, the receive module can provide one or more default shapes for selection by the user. Alternatively or additionally, the receive module also can provide an interface on a display device for the user to design the shape(s) of the selected application icons. The receive module receives the shapes of the selected application icons when the shapes are selected or designed by the user.

At block 403, a management module renders at least one of a title, a short menu, and a view window of the application software corresponding to each of the selected application icons. As illustrated in FIG. 5, when application software corresponding to one of the selected application icons is a media player, the management module can render at least one of a title “video,” a shortcut menu including previous button, a play button, and a next button, and a view window that can output the video. In one embodiment, the title, the short menu, and/or the view window of application software corresponding to each of the application icons can be preset and stored in a storage device.

At block 404, a management module further acquires usage frequencies of the application software corresponding to the selected application icons. In one embodiment, a storage device can includes a table to record the usage frequencies of the application software. In one embodiment, the usage frequencies may be determined over a period of a day or over another predetermined duration, such as over a period of a week or a month.

At block 405, a display module sequences the selected application icons according to the usage frequencies, and displays the selected application icons in a cascading style according to the sequencing and according to the shapes, such as illustrated in FIG. 6. In one embodiment, an application icon of application software which is used most frequently is at the beginning of the sequence. In one embodiment, when one application icon is selected, that application icon can be switched to the front of the sequence. In one embodiment, when displaying the selected application icons in a cascading style, the application icon other than the first application icon can show only their titles.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for managing and displaying application icons on an electronic device, the method executable by at least one processor of the electronic device and comprising:
detecting selection of one or more application icons corresponding to software applications installed in the electronic device;
rendering at least one of a title, a short menu, and a view window of the application software corresponding to each of the selected application icons;
acquiring usage frequencies of the application software corresponding to the selected application icons; and
sequencing the selected application icons according to the usage frequencies, and displaying the selected application icons in a cascading style according to the sequence.

2. The method according to claim 1, further comprising:
providing a list of application icons of the application software, and providing a check box to each of the application icons; and
identifying one of the application icon is selected when a corresponding check box is selected.

3. The method according to claim 1, further comprising:
receiving a shape of the selected application icons selected or designed by a user.

4. The method according to claim 2, wherein the shape of the selected application icons comprises circle, oval, rhombus, or an irregular shape.

5. The method according to claim 1, further comprising:
switching an application icon to the front of the sequence when the application icon is selected.

6. The method according to claim 1, wherein the application icons other than the first application icons only show their titles when displayed in a cascading style.

7. An electronic device, comprising:
a display device;
a controlling device; and
a storage device storing one or more programs which, when executed by the controlling device, causes the controlling device to:
detect one or more application icons of application software installed in an electronic device selected by a user;
render at least one of a title, a short menu, and a view window of the application software corresponding to each of the selected application icons;
acquire usage frequencies of the application software corresponding to the selected application icons; and
sequence the selected application icons according to the usage frequencies, and display the selected application icons in a cascading style according to the sequence.

8. The electronic device according to claim 7, wherein the controlling device further:
provides a list of application icons of the application software, and provides a check box to each of the application icons; and
identifies one of the application icon is selected when a corresponding check box is selected.

9. The electronic device according to claim 8, wherein the controlling device further:
receives a shape of the selected application icons selected or designed by a user.

10. The electronic device according to claim 9, wherein the shape of the selected application icons comprises circle, oval, rhombus, or an irregular shape.

11. The electronic device according to claim 7, wherein the controlling device further:
switches an application icon to the front of the sequence when the application icon is selected.

12. The electronic device according to claim 7, wherein the application icons other than the first application icons only show their titles when displayed in a cascading style.

13. A non-transitory storage medium having stored thereon instructions that, when executed by a processor of a computing device, causes the processor to perform a method for managing and displaying application icon, the method comprising:
detecting one or more application icons of application software installed in an electronic device selected by a user;
rendering at least one of a title, a short menu, and a view window of the application software corresponding to each of the selected application icons;
acquiring usage frequencies of the application software corresponding to the selected application icons; and
sequencing the selected application icons according to the usage frequencies, and displaying the selected application icons in a cascading style according to the sequence.

14. The non-transitory storage medium according to claim 13, wherein the method further comprises:
providing a list of application icons of the application software, and providing a check box to each of the application icons; and
identifying one of the application icon is selected when a corresponding check box is selected.

15. The non-transitory storage medium according to claim 14, wherein the method further comprises:
receiving a shape of the selected application icons selected or designed by a user.

16. The non-transitory storage medium according to claim 15, wherein the shape of the selected application icons comprises circle, oval, rhombus, or an irregular shape.

17. The non-transitory storage medium according to claim 13, wherein the method further comprises:
switching an application icon to the front of the sequence when the application icon is selected.

18. The non-transitory storage medium according to claim 13, wherein the application icons other than the first application icons only show their titles when displayed in a cascading style.
